(19) United States
(12) Patent Application Publication
(10) Pub. No.: US 2015/0103398 A1
(43) Pub. Date: Apr. 16, 2015

(54) IR REFLECTIVE COATING COMPATIBLE TO IR SENSORS

(71) Applicant: Toyota Motor Engineering & Manufacturing North America, Inc., Erlanger, KY (US)

(72) Inventors: Debasish Banerjee, Ann Arbor, MI (US); Li Qin Zhou, Ann Arbor, MI (US)

(21) Appl. No.: 14/460,067

(22) Filed: Aug. 14, 2014

Related U.S. Application Data
(63) Continuation-in-part of application No. 13/014,398, filed on Jan. 26, 2011.
Application No. 13/014,398 is a continuation-in-part of application No. 12/793,772, filed on Jun. 4, 2010, now Pat. No. 8,736,959.
Application No. 12/793,772 is a continuation-in-part of application No. 12/686,861, filed on Jan. 13, 2010, now Pat. No. 8,593,728.
Application No. 12/686,861 is a continuation-in-part of application No. 12/389,256, filed on Feb. 19, 2009, now Pat. No. 8,329,247.

(51) Int. Cl. G02B 5/28; G02B 5/08

(52) U.S. Cl. CPC G02B 5/282; G02B 5/285; G02B 5/0858
USPC 359/360

(57) ABSTRACT

An IR reflecting multilayer thin film. The IR reflecting multilayer thin film includes a multilayer stack having a multilayer packet with a metal layer sandwiched between a pair of dielectric layers. In addition, the inventive multilayer stack has a transmittance of at least 30% of infrared radiation having a wavelength of 850 nm and a total light energy transmission of less than 55%. The infrared reflecting multilayer thin film can extend across a glass substrate and thus reflect and prevent the IR radiation from passing through the glass substrate, thereby reducing the total light energy transmission through a glass panel.

### CROSS-REFERENCE TO RELATED APPLICATIONS

This application is a continuation-in-part of U.S. patent application Ser. No. 13/014,398 filed Jan. 26, 2011, entitled “Omnidirectional UV-IR Reflector” which is a continuation-in-part of U.S. patent application Ser. No. 12/793,772 filed Jun. 4, 2010 (U.S. Pat. No. 8,736,959), entitled “Omnidirectional Reflector” and U.S. patent application Ser. No. 12/686,861 filed Jan. 13, 2010 (U.S. Pat. No. 8,593,728), entitled “Multilayer Photonic Structures” which is a continuation-in-part of U.S. patent application Ser. No. 12/389,256 filed Feb. 19, 2009 (U.S. Pat. No. 8,329,247), entitled “Methods for Producing Omnidirectional Multilayer Photonic Structures”, all of which are incorporated herein in their entirety by reference.

### BACKGROUND OF THE INVENTION

Coatings that reduce infrared (IR) radiation transmittance through glass substrates or panels are known. Such coatings typically absorb electromagnetic radiation in the infrared range in order to reduce the transmission of IR radiation through the glass. In the alternative, coatings that reflect the IR radiation have been disclosed. However, IR reflective coatings have required many layers, e.g. up to 49 layers, in order to provide desired transmission and reflection properties. In addition, such coatings have not provided desired reductions in total light energy transmission which affords a reduction in heat accumulation within an enclosed interior such as a vehicle interior. Finally, heretofore known IR coatings have not been compatible with IR sensors, e.g. garage door openers, that typically use a wavelength of approximately 850 nanometers (nm). Therefore, an improved IR reflecting coating that is compatible with IR sensors and yet provides a desired reduction in total light energy transmission would be desirable.

### SUMMARY OF THE INVENTION

An IR reflecting multilayer thin film is provided. The IR reflecting multilayer thin film includes a multilayer stack having a multilayer packet, the multilayer packet having a metal layer sandwiched between a pair of high index of refraction dielectric layers. The metal layer can be any metallic layer known to those skilled in the art, illustratively including a silver layer, a gold layer, a copper layer, and the like. Also, the inventive multilayer stack has a transmittance of at least 30% of IR radiation with a wavelength of approximately 850 nm and a total light energy transmission of less than 55%. It is appreciated that the IR reflecting multilayer thin film can extend across a glass substrate and thus serves as an IR reflective coating that reflects and prevents IR radiation from passing through the glass substrate. In this manner, the IR reflective coating reduces total light energy transmission through a glass panel while allowing an IR sensor with a wavelength of approximately 850 nm to be used therewith.

In some instances, the multilayer packet is sandwiched between or within a pair of glass layers. In addition, the multilayer packet can be a first multilayer packet and a second multilayer packet that extends across the first multilayer packet is included. The second multilayer packet can have a high index of refraction dielectric layer sandwiched between a pair of low index of refraction dielectric layers, and the high index of refraction dielectric layers can have a refractive index greater than 2.0 and the low index of refraction layers can have a refractive index of less than 2.0. The high index of refraction dielectric layers can be any dielectric layers known to those skilled in the art having a refractive index greater than 2.0, illustratively including titanium dioxide (TiO₂). The low index of refraction dielectric layers can be any dielectric layers known to those skilled in the art having a refractive index less than 2.0, illustratively including halide salt layers, for example magnesium difluoride (MgF₂).

The multilayer stack can have an overall thickness of less than 500 nm, preferably less than 450 nm. In addition, the multilayer stack has less than 9 layers, preferably less than 7 layers, and in some instances a total of 6 layers.

The multilayer stack reflects more than 40% of IR radiation having a wavelength greater than 1000 nm and transmits at least 50% of visible radiation with wavelengths between 425-700 nm. Also, the multilayer stack allows at least 30% transmittance of IR radiation having a wavelength between 800-875 nm.

### BRIEF DESCRIPTION OF THE DRAWINGS

FIG. 1 is a schematic illustration of a multilayer stack on a glass substrate according to an embodiment of the present invention;

FIG. 2 is a schematic illustration of a multilayer stack on a glass substrate according to another embodiment of the present invention;

FIG. 3 is a schematic illustration of a multilayer stack between a pair of glass substrates according to another embodiment of the present invention;

FIG. 4 is a graphical plot illustrating transmittance and reflectance spectra from simulation (dotted lines) and experimental data (solid lines) for a multilayer stack on a normal laminated glass substrate according to an embodiment of the present invention;

FIG. 5A is a graphical plot for transmittance and reflectance spectra for a normal laminated glass substrate;

FIG. 5B is a graphical plot of transmittance and reflectance spectra for a coating on a normal laminated glass substrate according to an embodiment of the present invention;

FIG. 6A is a graphical plot of transmittance and reflectance spectra from an IR-cut laminated glass substrate;

FIG. 6B is a graphical plot of transmittance and reflectance spectra from a coating on an IR-cut laminated glass substrate according to an embodiment of the present invention;

FIG. 7A is a graphical plot of transmittance and reflectance spectra from a sound insulation laminated glass substrate;

FIG. 7B is a graphical plot of transmittance and reflectance spectra from a coating on a sound insulation laminated glass substrate according to an embodiment of the present invention;

FIG. 8 is a graphical plot of transmittance of IR radiation with a wavelength of 850 nm for coatings according to an embodiment of the present invention on a normal laminated glass substrate, an IR-cut laminated glass substrate, and a sound insulation laminated glass substrate; and

FIG. 9 is a graphical plot of total transmitted solar energy (% TTs) for coatings according to an embodiment of the present invention on a normal laminated glass substrate, an IR-cut laminated glass substrate, and a sound insulation laminated glass substrate.

### DETAILED DESCRIPTION OF THE INVENTION

The present invention provides an IR reflecting multilayer thin film that reduces heat generated with an enclosed environment and yet is compatible with IR sensors. As such, the present invention has utility as an IR reflecting film or coating that can be used on vehicle windows, the coating allowing for the use of sensors such as garage door openers from within an interior of the vehicle. The present invention also has use for reducing heat within a vehicle interior, thereby improving the overall efficiency of the vehicle.

The IR reflecting multilayer thin film includes a multilayer stack that has a multilayer packet. The multilayer packet has a metal layer that is sandwiched between a pair of high index of refraction dielectric layers. The metal layer can be made from any metal or alloy known to those skilled in the art, illustratively including gold, copper, silver, aluminum, iron, chromium, tin, nickel, cobalt, titanium, zinc, niobium, molybdenum and alloys thereof.

In addition, the multilayer stack has a transmittance of at least 30% of IR radiation having a wavelength of approximately 850 nm, e.g. 850±10 nm, and also has a total light energy transmission of less than 55%. Naturally, a glass substrate can be included and the multilayer stack extends across the glass substrate in the form of a coating. In some instances, the glass substrate can be a laminated glass substrate and the multilayer stack may or may not be sandwiched between a pair of glass layers.

The multilayer packet can be a first multilayer packet and the IR reflecting multilayer thin film can further include a second multilayer packet that extends across the first multilayer packet. The second multilayer packet has a high index of refraction dielectric layer that is sandwiched between a pair of low index of refraction dielectric layers and the high index of refraction dielectric layers have a refractive index greater than 2.0 and the low index of refraction dielectric layers have a refractive index less than 2.0. The dielectric layers can be made from any dielectric material known to those skilled in the art. For example and for illustrative purposes only, the high index of refraction dielectric layers can be TiO₂ layers and the low index of refraction layers can be MgF₂ layers, or in the alternative, one of the materials listed below in Table 1.

TABLE 1

| Refractive Index Materials | | Refractive Index Materials | |
|---|---|---|---|
| (visible region) | | (visible region) | |
| | Refractive | | Refractive |
| Material | Index | Material | Index |
| Germanium (Ge) | 4.0-5.0 | Chromium (Cr) | 3.0 |
| Tellurium (Te) | 4.6 | Tin Sulfide (SnS) | 2.6 |
| Gallium Antimonite (GaSb) | 4.5-5.0 | Low Porous Si | 2.56 |
| Indium Arsenide (InAs) | 4.0 | Chalcogenide glass | 2.6 |
| Silicon (Si) | 3.7 | Cerium Oxide (CeO₂) | 2.53 |
| Indium Phosphate (InP) | 3.5 | Tungsten (W) | 2.5 |
| Gallium Arsenate (GaAs) | 3.53 | Gallium Nitride (GaN) | 2.5 |
| Gallium Phosphate (GaP) | 3.31 | Manganese (Mn) | 2.5 |
| Vanadium (V) | 3 | Niobium Oxide (Nb₂O₃) | 2.4 |
| Arsenic Selenide (As₂Se₃) | 2.8 | Zinc Telluride (ZnTe) | 3.0 |
| CuAlSe₂ | 2.75 | Chalcogenide glass + Ag | 3.0 |
| Zinc Selenide (ZnSe) | 2.5-2.6 | Zinc Sulfide (ZnS) | 2.5-3.0 |
| Titanium Dioxide (TiO₂) - | 2.36 | Titanium Dioxide (TiO₂) - | 2.43 |
| solgel | | vacuum deposited | |
| Alumina Oxide (Al2O3) | 1.75 | Hafnium Oxide (HfO₂) | 2.0 |
| Yttrium Oxide (Y2O3) | 1.75 | Sodium Aluminum Fluoride | 1.6 |
| | | (Na3AlF6) | |
| Polystyrene | 1.6 | Polyether Sulfone (PES) | 1.55 |
| Magnesium Fluoride | 1.37 | High Porous Si | 1.5 |
| (MgF2) | | | |
| Lead Fluoride (PbF2) | 1.6 | Indium Tin Oxide nanorods | 1.46 |
| | | (ITO) | |
| Potassium Fluoride (KF) | 1.5 | Lithium Fluoride (LiF4) | 1.45 |
| Polyethylene (PE) | 1.5 | Calcium Fluoride | 1.43 |
| Barium Fluoride (BaF2) | 1.5 | Strontium Fluoride (SrF2) | 1.43 |
| Silica (SiO2) | 1.5 | Lithium Fluoride (LiF) | 1.39 |
| PMMA | 1.5 | PKFE | 1.6 |
| Aluminum Arsenate (AlAs) | 1.56 | Sodium Fluoride (NaF) | 1.3 |
| Solgel Silica (SiO2) | 1.47 | Nano-porous Silica (SiO2) | 1.23 |
| N,N′ bis(1naphthyl)- | 1.7 | Sputtered Silica (SiO2) | 1.47 |
| 4,4′Diamine (NPB) | | | |
| Polyamide-imide (PEI) | 1.6 | Vacuum Deposited Silica | 1.46 |
| | | (SiO2) | |
| Zinc Sulfide (ZnS) | 2.3 + | Niobium Oxide (Nb₂O₅) | 2.1 |
| | i(0.015) | | |
| Titanium Nitride (TiN) | 1.5 + | Aluminum (Al) | 2.0 + |
| | i(2.0) | | i(15) |
| Chromium (Cr) | 2.5 + | Silicon Nitride (SiN) | 2.1 |
| | i(2.5) | | |
| Niobium Pentoxide(Nb2O5) | 2.4 | Mica | 1.56 |
| Zirconium Oxide (ZrO2) | 2.36 | Polyallomer | 1.492 |
| Hafnium Oxide (HfO2) | 1.9-2.0 | Polybutylene | 1.50 |
| Fluorcarbon (FEP) | 1.34 | Ionomers | 1.51 |
| Polytetrafluro-Ethylene | 1.35 | Polyethylene (Low Density) | 1.51 |
| (TFE) | | | |
| Fluorcarbon (FEP) | 1.34 | Nylons (PA) Type II | 1.52 |
| Polytetrafluro- | 1.35 | Acrylics Multipolymer | 1.52 |
| Ethylene(TFE) | | | |
| Chlorotrifiuoro- | 1.42 | Polyethylene | 1.52 |
| Ethylene(CTFE) | | (Medium Density) | |
| Cellulose Propionate | 1.46 | Styrene Butadiene | 1.52-1.55 |
| | | Thermoplastic | |
| Cellulose Acetate Butyrate | 1.46-1.49 | PVC (Rigid) | 1.52-1.55 |
| Cellulose Acetate | 1.46-1.50 | Nylons (Polyamide) | 1.53 |
| | | Type 6/6 | |
| Methylpentene Polymer | 1.485 | Urea Formaldehyde | 1.54-1.58 |
| Acetal Homopolymer | 1.48 | Polyethylene | 1.54 |
| | | (High Density) | |
| Acrylics | 1.49 | Styrene Acrylonitrile | 1.56-1.57 |
| | | Copolymer | |
| Cellulose Nitrate | 1.49-1.51 | Polystyrene | 1.57-1.60 |
| | | (Heat & Chemical) | |
| Ethyl Cellulose | 1.47 | Polystyrene | 1.59 |
| | | (General Purpose) | |
| Polypropylene | 1.49 | Polycarbornate | 1.586 |
| | | (Unfilled) | |
| Polysulfone | 1.633 | SnO2 | 2.0 |

The metal layer that is sandwiched between the pair of high index of refraction dielectric layers can be any metal or alloy known to those skilled in the art that affords for the first multilayer packet in combination with the pair of dielectric layers to transmit at least 30% of IR radiation having a center wavelength of approximately 850 nm and a total light energy transmission of less than 55%. Exemplary metal layers are layers made from gold, silver, copper and alloys thereof.

The overall thickness of the multilayer stack is less than 500 nm. Preferably, the overall thickness is less than 450 nm and the stack has less than 9 layers. In some instances, the multilayer stack has less than 7 layers and can have a total of 6 layers.

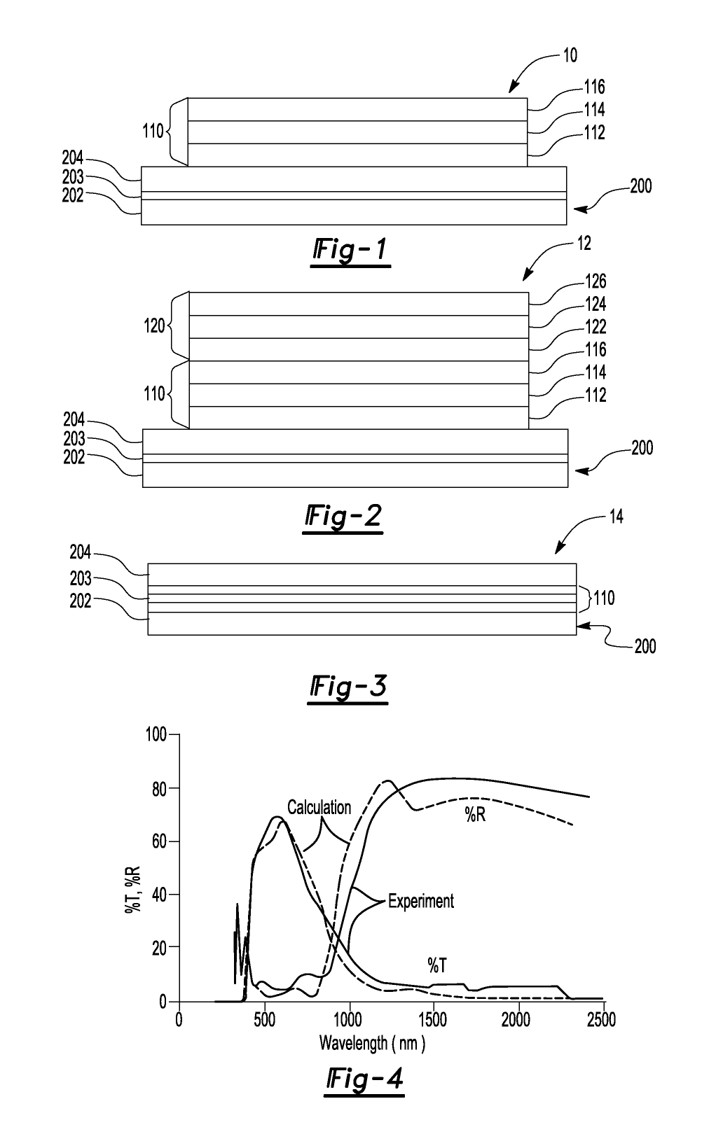

Turning now to FIG. 1, a schematic illustration of an embodiment of the present invention is shown generally at reference numeral 10. The infrared reflecting multilayer thin film 10 has a first multilayer packet 110 that includes a metal layer 114 sandwiched between a first dielectric layer 112 and a second dielectric layer 116. The second dielectric layer 116 may or may not be made from the same material and/or be the same thickness as the first dielectric layer 112.

Naturally, the first multilayer packet 110 can be on and/or extend across a glass substrate 200. The glass substrate 200 may or may not be a laminated glass substrate that has a first glass layer 202, a second glass layer 204, and an optional layer 203 sandwiched therebetween.

The IR reflecting multilayer thin film 10 allows for at least 50% transmittance of visible light with wavelengths between 425-700 nm, at least 30% transmittance of IR radiation having a wavelength of 850 nm, and reduces total light energy transmission through a glass substrate to less than 55%. It is appreciated that values for the total transmitted solar energy are calculated using transmittance and reflectance spectra of the IR reflective coatings using the ISO 13837 standard. It is also appreciated that the ISO 13837 standard specifies test methods to determine the direct and total solar transmittance of safety glazing materials for road vehicles. Two computational conventions are included in ISO 13837, both of which are consistent with current international needs and practices. In addition, the ISO 13837 standard applies to monolithic or laminated, clear or tinted samples of safety glazing materials. This standard is known to those skilled in the art and is included herein in its entirety by reference.

Turning now to FIG. 2, another embodiment of the present invention is shown generally at reference numeral 12. The IR reflecting multilayer thin film 12 is similar to the embodiment shown in FIG. 1 with the addition of a second multilayer packet 120. The second multilayer packet 120 has a first low index of refraction layer 122, a high index of refraction layer 124, and another low index of refraction layer 126. The low index of refraction layers 122 and 126 each have a refractive index of less than 2.0, whereas the high index of refraction layer 124 has a refractive index of greater than 2.0. In some instances, the low index of refraction layers 122 and 126 can be made from the same material; however, this is not required. In addition, the layers 122 and 126 can have the same thickness; however, again this is not required.

For example and for illustrative purposes only, the layers 122 and 126 can be made from a low index of refraction dielectric material such as MgF₂. Also, the high index of refraction layer 124 may or may not be the same as the layers 112 and/or 116. Finally, the glass substrate 200 can be a laminated substrate with the first glass layer 202, second glass layer 204, and third layer 203 sandwiched therebetween.

The embodiments shown in FIGS. 1 and 2 illustrate that the IR reflecting multilayer thin film extends across an outer surface of the glass substrate 200. However, in some instances, the IR reflecting multilayer thin film with the first multilayer packet 110 or the first and second multilayer packets 110, 120 can be sandwiched between the glass layers 202 and 204 as shown in FIG. 3. For example, the layer 203 between the glass layers 202 and 204 can be an IR reflecting multilayer thin film 110. However, an IR reflecting multilayer thin film 110 can be located between the glass layers 202 and 204, in addition to the third layer 203.

With respect to the reflecting and transmitting properties of the IR reflecting multilayer thin films disclosed herein, FIG. 4 provides a graphical plot for an IR reflecting multilayer thin film on a normal laminated glass substrate. The IR reflecting multilayer thin film used to produce the results shown in FIG. 4 was a 6 layer thin film with a first multilayer packet having a layer of gold between or sandwiched between a pair of TiO₂ layers, and a second multilayer packet having a TiO₂ layer sandwiched between a pair of MgF₂ layers. The total thickness of the multilayer stack was approximately 430 nm. In addition, simulation of the percent transmitted and the percent reflected by the inventive coating was compared with experimental data. FIG. 4 illustrates that the simulation data have a reasonably good correlation with actual performance data of the material.

FIG. 4 also illustrates that for wavelengths between approximately 400-425 nm and 700 nm, the laminated glass substrate with the IR reflecting multilayer thin film discussed above transmits over 50% of visible light. In addition, at a wavelength of approximately 850 nm, the laminated glass plus coating allowed for more than 30% transmittance.

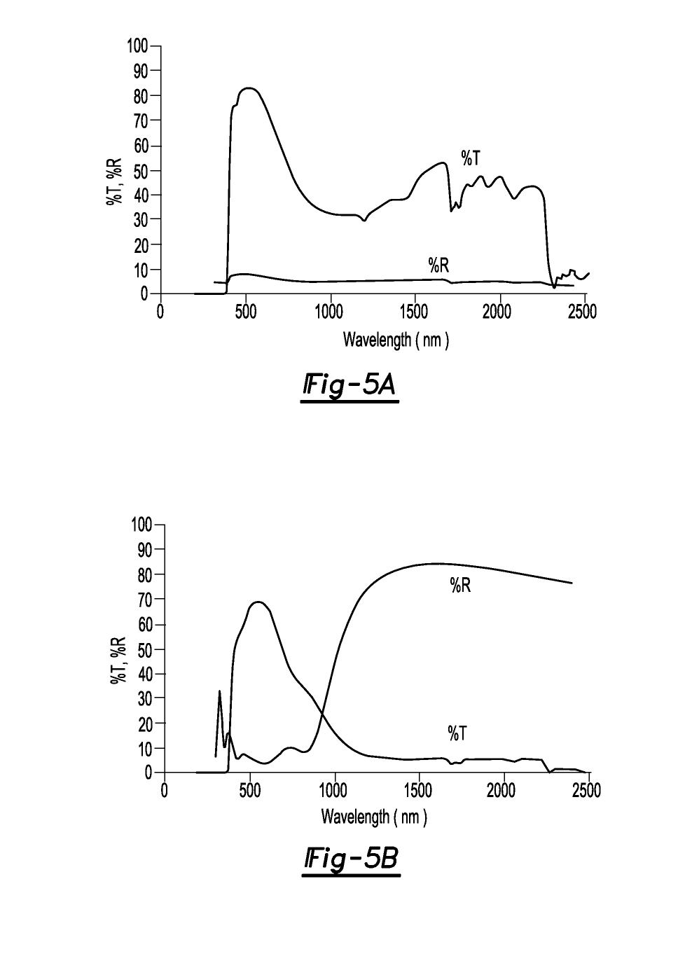

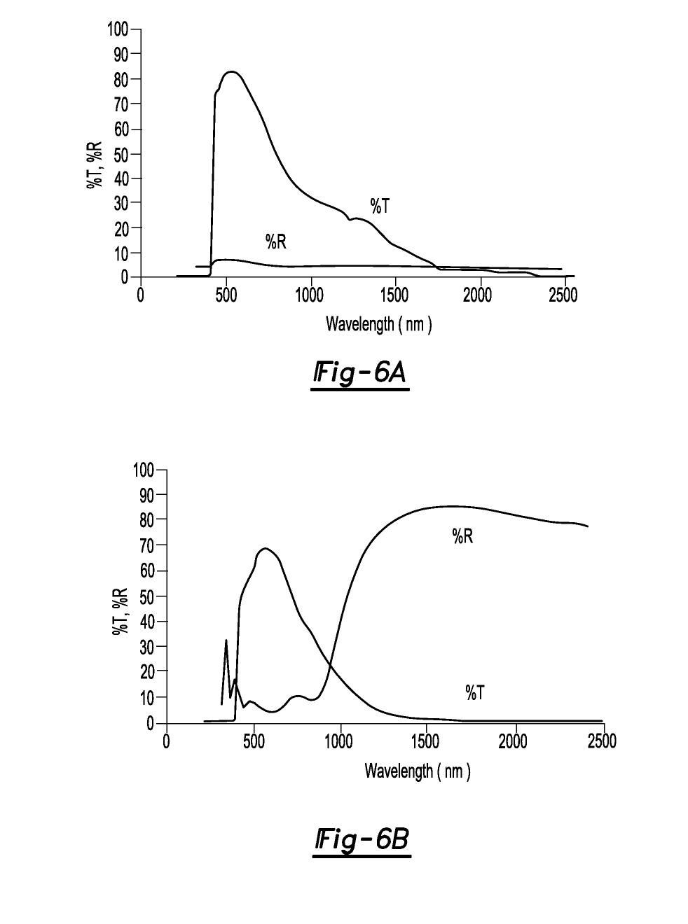

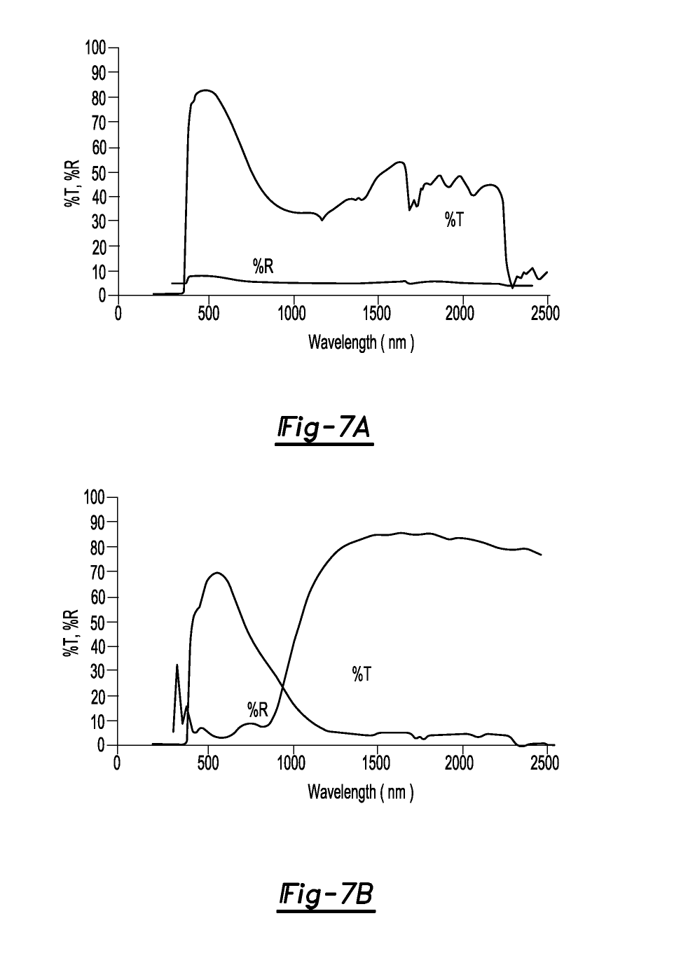

Turning now to FIGS. 5A and 5B, a comparison between transmittance and reflectance for normal laminated glass and transmittance and reflectance for the same normal laminated glass plus an inventive coating is shown. In addition, FIGS. 6A and 6B show a similar comparison for an IR-cut laminated glass (FIG. 6A) and the same IR-cut laminated glass with an inventive coating (FIG. 6B). Finally, FIG. 7A shows the transmittance and reflectance for a sound insulation laminated glass whereas FIG. 7B shows the transmittance and reflectance for the same sound insulation laminated glass with the inventive coating.

As evidenced by FIGS. 6 and 7, the transmittance and reflectance properties of the inventive coating are similar for each type of glass. In addition, the figures show that over 50% of visible light is transmitted through the glass with the inventive coating whereas IR radiation having a wavelength of 850 nm is transmitted to a degree of at least 30%. Also, at least 40% of IR radiation having a wavelength equal to or greater than 1000 nm is reflected and at least 70% of IR radiation with a wavelength equal to or greater than 1200 nm is reflected.

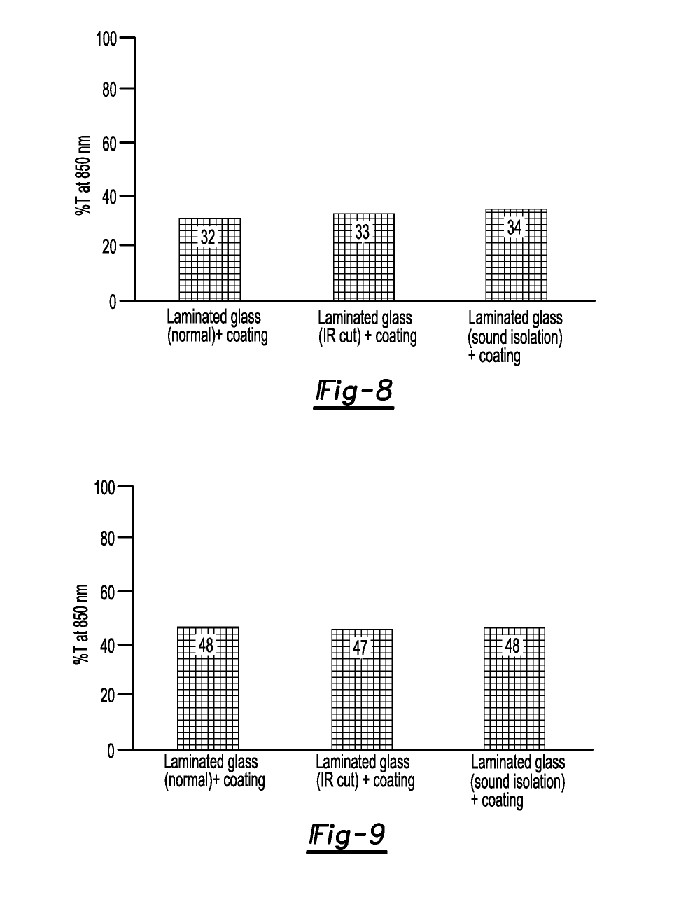

Turning now to FIG. 8, the percent of transmittance for IR radiation having a wavelength of 850 nm is shown for the three glasses with the inventive coating mentioned above. As shown in the figure, a transmittance of at least 30% is provided. In addition, FIG. 9 shows that the three glasses with the inventive coating had a total transmitted solar energy of less than 55%. Therefore, the inventive coating affords for an IR reflecting film that reduces total transmitted solar energy and yet allows for IR sensors such as garage door openers to be transmitted therethrough.

Changes, modifications, and the like will be apparent to those skilled in the art and yet still fall within the scope of the invention. As such, the scope of the invention is defined by the claims and all equivalents thereof.

We claim:

1. An infrared reflecting multilayer thin film comprising:
a multilayer stack having a first multilayer packet;
said first multilayer packet having a metal layer sandwiched between a pair of high index of refraction dielectric layers; and
said multilayer stack has a transmittance of at least 30% of infrared radiation having a wavelength of 850 nm and a total light energy transmission of less than 55%.

2. The infrared reflecting multilayer thin film of claim 1, further comprising a glass substrate, said multilayer stack extending across said glass substrate.

3. The infrared reflecting multilayer thin film of claim 2, wherein said first multilayer packet is sandwiched between a pair of glass substrate layers.

4. The infrared reflecting multilayer thin film of claim 3, further comprising a second multilayer packet extending across said first multilayer packet and having a high index of refraction dielectric layer sandwiched between a pair of low index of refraction dielectric layers.

5. The infrared reflecting multilayer thin film of claim 4, wherein said high index of refraction index dielectric layers have a refractive index greater than 2.0 and said pair of low index of refraction index dielectric layers have a refractive index less than 2.0.

6. The infrared reflecting multilayer thin film of claim 5, wherein said high index of refraction dielectric layers are selected from the group consisting of TiO₂ layers, ZnS layers, ZrO₂ layers, Nb₂O₅ layers, ZnSe layers, SnS layers, CeO₂ layers and combinations thereof.

7. The infrared reflecting multilayer thin film of claim 6, wherein said pair of low index of refraction index dielectric layers are selected from the group consisting of MgF₂ layers, SiO₂ layers, NaF layers, LiF layers, LiF₄ layers, PbF₂ layers, Y₂O₃ layers, Al₂O₃ layers and combinations thereof.

8. The infrared reflecting multilayer thin film of claim 7, wherein said metal layer is a gold layer.

9. The infrared reflecting multilayer thin film of claim 7, wherein said metal layer is a copper layer.

10. The infrared reflecting multilayer thin film of claim 7, wherein said metal layer is a layer selected from the group consisting of a silver layer, an aluminum layer, an iron layer, a chromium layer, a tin layer, a nickel layer, a cobalt layer, a titanium layer, a zinc layer, a niobium layer, a molybdenum layer, and alloys thereof.

11. The infrared reflecting multilayer thin film of claim 9, wherein said multilayer stack has an overall thickness of less than 1 μm.

12. The infrared reflecting multilayer thin film of claim 11, wherein said overall thickness is less than 450 nm.

13. The infrared reflecting multilayer thin film of claim 9, wherein said multilayer stack has less than 9 layers.

14. The infrared reflecting multilayer thin film of claim 13, wherein said multilayer stack has less than 7 layers.

15. The infrared reflecting multilayer thin film of claim 14, wherein said multilayer stack has a total of 6 layers.

16. The infrared reflecting multilayer thin film of claim 14, wherein said multilayer stack reflects more than 35% of infrared radiation having a wavelength greater than 1000 nm.

17. The infrared reflecting multilayer thin film of claim 15, wherein said multilayer stack and glass substrate transmits at least 50% of visible radiation with wavelengths between 425-700 nm.

18. The infrared reflecting multilayer thin film of claim 16, wherein said multilayer stack has at least 30% transmittance of infrared radiation having a wavelength between 800-875 nm.

19. An infrared reflecting multilayer thin film comprising:
a glass substrate;
a multilayer stack extending across said glass substrate and having a first multilayer packet and a second multilayer packet;
said first multilayer packet having a metal layer sandwiched between a pair of high index of refraction dielectric layers and said second multilayer packet extending across said first multilayer packet and having a high index of refraction dielectric layer sandwiched between a pair of low index of refraction dielectric layers; and
said multilayer stack having a transmittance of at least 30% of infrared radiation having a wavelength of 850 nm and a total light energy transmission of less than 55% when exposed to sunlight.

20. The infrared reflecting multilayer thin film of claim 18, wherein said high index of refraction dielectric layers have a refractive index greater than 2.0 and said pair of low index of refraction dielectric layers have a refractive index less than 2.0.
